(19) United States
(12) Patent Application Publication
(10) Pub. No.: US 2019/0372074 A1
(43) Pub. Date: Dec. 5, 2019

(54) NONAQUEOUS ELECTROLYTE SECONDARY BATTERY SEPARATOR

(71) Applicant: Sumitomo Chemical Company, Limited, Tokyo (JP)

(72) Inventors: Yuichiro AZUMA, Osaka (JP); Tomoaki OZEKI, Niihama-shi (JP)

(21) Appl. No.: 16/428,139

(22) Filed: May 31, 2019

(30) Foreign Application Priority Data
Jun. 1, 2018 (JP) 2018-106361

(51) Int. Cl. H01M 2/16

(52) U.S. Cl. CPC H01M 2/1653; H01M 2/1686

(57) ABSTRACT

A nonaqueous electrolyte secondary battery separator having reduced anisotropy of deformation after immersion in an electrolyte is provided. The nonaqueous electrolyte secondary battery separator includes a polyolefin porous film. E_{MaxB}, E_{MinB}, E_{Max24}, and E_{Min24}, which are tensile elastic moduli of the nonaqueous electrolyte secondary battery separator as measured via a specific method, satisfy the following Expression 1:

(E_{Min24}/E_{MinB})/(E_{Max24}/E_{MaxB})≥0.80 Expression 1.

This Nonprovisional application claims priority under 35 U.S.C. § 119 on Patent Application No. 2018-106361 filed in Japan on Jun. 1, 2018, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”), a laminated separator for a nonaqueous electrolyte secondary battery (hereinafter referred to as a “nonaqueous electrolyte secondary battery laminated separator”), a member for a nonaqueous electrolyte secondary battery member (hereinafter referred to as a “nonaqueous electrolyte secondary battery member”), and a nonaqueous electrolyte secondary battery.

### BACKGROUND ART

Nonaqueous electrolyte secondary batteries, particularly lithium-ion secondary batteries, have a high energy density, and are therefore in wide use as batteries for devices such as personal computers, mobile telephones, and portable information terminals. Such nonaqueous electrolyte secondary batteries have recently been developed as on-vehicle batteries.

Patent Literature 1 discloses a heat-resistant synthetic resin porous film having a dimensional change rate, as observed upon immersion in dimethyl carbonate, of not more than 0.8%

### CITATION LIST

### Patent Literature

### Patent Literature 1

Japanese Patent Application Publication, Tokukai, No. 2016-199734

### SUMMARY OF INVENTION

### Technical Problem

However, in such conventional art, there is room for improvement in terms of reducing anisotropy of deformation of a separator which deformation occurs after immersion in an electrolyte. Patent Literature 1 discloses controlling a dimensional change rate as observed after 30 minutes of immersion in an electrolyte. However, in such conventional art, there is room for further improvement in terms of controlling anisotropy of deformation of a separator which deformation occurs after immersion in an electrolyte. In other words, even if anisotropy of deformation of a separator is prevented with regard to deformation occurring after 30 minutes of immersion, anisotropy of deformation of the separator can still occur after immersion in an electrolyte for an even longer period.

An object of an aspect of the present invention lies in providing a nonaqueous electrolyte secondary battery separator having reduced anisotropy of deformation which deformation occurs after immersion in an electrolyte.

### Solution to Problem

A nonaqueous electrolyte secondary battery separator in accordance with Aspect 1 of the present invention includes a polyolefin porous film, the nonaqueous electrolyte secondary battery separator satisfying the following Expression 1:

(E_{Min24}/E_{MinB})/(E_{Max24}/E_{MaxB})≥0.80 (Expression 1)

where E_{MaxB}, E_{MinB}, E_{Max24}, and E_{Min24} are each a tensile elastic modulus of respective ones of test pieces obtained from the nonaqueous electrolyte secondary battery separator, E_{MaxB} being a tensile elastic modulus as observed (i) before immersion in propylene carbonate and (ii) in a direction in which tensile elastic modulus is highest, E_{MinB} being a tensile elastic modulus as observed (i) before immersion in propylene carbonate and (ii) in a direction in which tensile elastic modulus is lowest, E_{Max24} being a tensile elastic modulus as observed (i) after 24 hours of immersion in propylene carbonate and (ii) in a direction in which tensile elastic modulus is highest, E_{Min24} being a tensile elastic modulus as observed (i) after 24 hours of immersion in propylene carbonate and (ii) in a direction in which tensile elastic modulus is lowest.

A nonaqueous electrolyte secondary battery laminated separator in accordance with Aspect 2 of the present invention includes: the nonaqueous electrolyte secondary battery separator of Aspect 1; and a porous layer.

In Aspect 3 of the present invention, the nonaqueous electrolyte secondary battery laminated separator of Aspect 2 is configured such that the porous layer contains at least one resin selected from the group consisting of a (meth)acrylate-based resin, a fluorine-containing resin, a polyamide-based resin, a polyimide-based resin, a polyester-based resin, and a water-soluble polymer.

In Aspect 4 of the present invention, the nonaqueous electrolyte secondary battery laminated separator of Aspect 3 is configured such that the polyamide-based resin is an aramid resin.

A nonaqueous electrolyte secondary battery member in accordance with Aspect 5 of the present invention includes: a positive electrode; the nonaqueous electrolyte secondary battery separator of Aspect 1 or the nonaqueous electrolyte secondary battery laminated separator of any one of Aspects 2 to 4; and a negative electrode, the positive electrode, the nonaqueous electrolyte secondary battery separator or the nonaqueous electrolyte secondary battery laminated separator, and the negative electrode being arranged in this order.

A nonaqueous electrolyte secondary battery in accordance with Aspect 6 of the present invention includes: the nonaqueous electrolyte secondary battery separator of Aspect 1 or the nonaqueous electrolyte secondary battery laminated separator of any one of Aspects 2 to 4.

### Advantageous Effects of Invention

An aspect of the present invention makes it possible to provide a nonaqueous electrolyte secondary battery separator having reduced anisotropy of deformation which deformation occurs after immersion in an electrolyte.

### BRIEF DESCRIPTION OF DRAWINGS

FIG. 1 is a diagram schematically illustrating shrinkage of a porous film and a porous layer caused by drying.

### DESCRIPTION OF EMBODIMENTS

The following description will discuss embodiments of the present invention. Note, however, that the present invention is not limited to the embodiment. The present invention is not limited to arrangements described below, but may be altered in various ways by a skilled person within the scope of the claims. The present invention also encompasses, in its technical scope, any embodiment derived by combining technical means disclosed in differing embodiments.

Note that a numerical expression “A to B” herein means “not less than A and not more than B” unless otherwise stated. Furthermore, the term “machine direction” (MD) as used herein refers to a direction in which a separator original sheet is conveyed. The term “transverse direction” (TD) as used herein refers to a direction which is parallel to a surface of the separator original sheet and is perpendicular to the machine direction.

[1. Nonaqueous Electrolyte Secondary Battery Separator]

A nonaqueous electrolyte secondary battery separator in accordance with an embodiment of the present invention includes a polyolefin porous film and satisfies the following Expression 1:

(E_{Min24}/E_{MinB})/(E_{Max24}/E_{MaxB})≥0.80 (Expression 1).

In the present specification, a “nonaqueous electrolyte secondary battery separator” may also be referred to simply as a “separator.” Furthermore, “before a test piece is immersed in propylene carbonate” may be written as simply “before immersion,” and “after a test piece is immersed in propylene carbonate for 24 hours” may be written simply as “after immersion”.

E_{MaxB} is a tensile elastic modulus of a test piece obtained from the separator. Specifically, E_{MaxB} is a tensile elastic modulus as observed (i) before immersion in propylene carbonate and (ii) in a direction in which tensile elastic modulus is highest. E_{MinB} is a tensile elastic modulus of a test piece obtained from the separator. Specifically, E_{MinB} is a tensile elastic modulus as observed (i) before immersion in propylene carbonate and (ii) in a direction in which tensile elastic modulus is lowest.

E_{Max24} is a tensile elastic modulus of a test piece obtained from the separator. Specifically, E_{Max24} is a tensile elastic modulus as observed (i) after 24 hours of immersion in propylene carbonate and (ii) in a direction in which tensile elastic modulus is highest. E_{Min24} is a tensile elastic modulus of a test piece obtained from the separator. Specifically, E_{Min24} is a tensile elastic modulus as observed (i) after 24 hours of immersion in propylene carbonate and (ii) in a direction in which tensile elastic modulus is lowest.

A higher tensile elastic modulus correlates to greater resistance to deformation, whereas a lower tensile elastic modulus correlates to less resistance to deformation. The tensile elastic modulus can be calculated from the slope of a stress-strain curve. A method of measuring the tensile elastic modulus will be described in detail later in the Examples.

In the present specification, the direction in which the tensile elastic modulus of a test piece is highest may also be referred to as a “high tensile elastic modulus direction”. Likewise, a direction in which the tensile elastic modulus of a test piece is lowest may also be referred to as a “low tensile elastic modulus direction”. The high tensile elastic modulus direction and the low tensile elastic modulus direction can also be described as being the two directions between which a difference in tensile elastic modulus is greatest. Typically, the high tensile elastic modulus direction is the machine direction (MD) and the low tensile elastic modulus direction is the transverse direction (TD). This is presumably because, during conveyance of a separator original sheet, tension is applied in the machine direction.

E_{MaxB} and E_{Max24} are both a tensile elastic modulus measured in a longitudinal direction of a test piece, the test piece having been cut out from a separator such that the longitudinal direction of the test piece is the high tensile elastic modulus direction. E_{MinB} and E_{Min24} are both a tensile elastic modulus measured in a longitudinal direction of a test piece, the test piece having been cut out from the separator such that the longitudinal direction of the test piece is the low tensile elastic modulus direction.

As described above, typically, the high tensile elastic modulus direction is the machine direction (MD) and the low tensile elastic modulus direction is the transverse direction (TD). As such, in a case where test pieces are produced from a long separator or a separator roll, E_{MaxB} and E_{Max24} can be measured from a test piece which has been cut so that the longitudinal direction of the test piece is the machine direction, and E_{MaxB} and E_{Min24} can be measured from a test piece which has been cut so that the longitudinal direction of the test piece is the transverse direction.

However, in a sheet-type separator, i.e., a separator which has been processed to a predetermined size, it can be difficult to distinguish between the transverse direction and the machine direction. Because the high tensile elastic modulus direction is typically the machine direction and the low tensile elastic modulus direction is typically the transverse direction as described above, the high tensile elastic modulus direction and the low tensile elastic modulus direction are orthogonal to each other in a separator original sheet. As such, if a sheet-type separator is rectangular in shape, then tensile elastic modulus measurements can be performed on (i) a test piece prepared such that the longitudinal direction of the test piece is parallel to a first side of the rectangle and (ii) a test piece prepared such that the longitudinal direction of the test piece is perpendicular to the first side of the rectangle. Then, a direction found to have a higher tensile elastic modulus can be determined as being the high tensile elastic modulus direction, and a direction found to have a lower tensile elastic modulus can be determined as being the low tensile elastic modulus direction.

In a case where the transverse direction and machine direction of a separator are unknown, tensile elastic modulus measurements may be carried out on test pieces prepared with respect to a discretionarily selected plurality of directions. Then, out of the plurality of directions, a direction found to have the highest tensile elastic modulus can be determined as being the high tensile elastic modulus direction, and a direction found to have the lowest tensile elastic modulus can be determined as being the low tensile elastic modulus direction. Alternatively, a direction found to have the highest tensile elastic modulus can be determined as being the high tensile elastic modulus direction, and a direction perpendicular to the high tensile elastic modulus direction can be determined as being the low tensile elastic modulus direction. Note that in the present specification, the “shape” of a separator refers to the shape of a surface of the separator which surface is perpendicular to the thickness direction of the separator.

E_{Max24}/E_{MaxB} is a ratio of the high tensile elastic modulus direction after immersion to the high tensile elastic modulus direction before immersion. E_{Min24}/E_{MinB} is a ratio of the low tensile elastic modulus direction after immersion to the low tensile elastic modulus direction before immersion. Immersion in an electrolyte causes a separator to soften. As a result, the separator tends to have a decreased tensile elastic modulus after immersion. E_{Max24}/E_{MaxB} and E_{Min24}/E_{MinB} each express a degree of softening of a separator. A smaller value of E_{Max24}/E_{MaxB} and E_{Min24}/E_{MaxB} indicates that the separator is more easily deformed after immersion.

(E_{Min24}/E_{MinB})/(E_{Max24}/E_{MaxB}) is a ratio of a change in tensile elastic modulus in the low tensile elastic modulus direction to a change in tensile elastic modulus in the high tensile elastic modulus direction. In other words, (E_{Min24}/E_{MinB})/(E_{Max24}/E_{MaxB}) is a parameter that expresses isotropy of softening of a separator which softening occurs due to immersion in an electrolyte. A value of (E_{Min24}/E_{MinB})/(E_{Max24}/E_{MaxB}) which is closer to 1 indicates a higher degree of isotropy of softening of the separator.

The inventors of the present invention independently discovered that, in order to solve the above-described problem, rather than merely controlling the degree of softening of a separator after immersion, it is important to control the isotropy of such softening. In other words, in an embodiment of the present invention, anisotropy of deformation of a separator, which deformation occurs after immersion in an electrolyte, is reduced by reducing anisotropy of softening.

In a case where the value of (E_{Min24}/E_{MinB})/(E_{Max24}/E_{MaxB}) is not less than 0.80, the separator softens isotropically after immersion in an electrolyte. As such the resin component of the separator deforms isotropically. Therefore, such a value of (E_{Min24}/E_{MinB})/(E_{Max24}/E_{MaxB}) makes it possible to reduce anisotropy of deformation of the separator. Note that when an electrode is being laminated to a separator, a redundant area of a separator can be decreased due to, for example, misalignment or shifting of the separator. The phrase “redundant area of a separator” refers to an area, of a separator to which an electrode has been laminated, which area is not in contact with the electrode. Even if the redundant area is reduced, a separator in which the value of (E_{Min24}/E_{MinB})/(E_{Max24}/E_{MaxB}) is not less than 0.80 will elongate uniformly after immersion in an electrolyte. As such, even if the electrode expands due to charging, it is possible to reduce the likelihood of a short circuit. Furthermore, even if the lamination conditions are changed to some degree, it is possible to carry out lamination without a decrease in the safety of the battery. As such, the separator is suitable for a wider range of processing.

In contrast, in a case where the value of (E_{Min24}/E_{MinB})/(E_{Max24}/E_{MaxB}) is less than 0.80, there is directional bias in the deformation of the separator. In such a case, the separator will deform in a direction more prone to softening, that is, in the low tensile elastic modulus direction. As such, there is a large degree of anisotropy of deformation of the separator, which deformation occurs after immersion in an electrolyte. Furthermore, in a case where the value of (E_{Min24}/E_{MinB})/(E_{Max24}/E_{MaxB}) is less than 0.80, the separator will elongate primarily in one direction. Because of this, when immersed in an electrolyte, the separator will not elongate in the direction less prone to deformation. Thus, in a case where the separator has only a small redundant area in the direction less prone to deformation, a short circuit may occur if the electrode expands due to charging. The value of (E_{Min24}/E_{MinB})/(E_{Max24}/E_{MaxB}) is more preferably not less than 0.85 and even more preferably not less than 0.90. The value of (E_{Min24}/E_{MinB})/(E_{Max24}/E_{MaxB}) is preferably not more than 1.00.

The anisotropy of softening between the high tensile elastic modulus direction and the low tensile elastic modulus direction presumably reflects residual stress generated in a polyolefin porous film in the production process of a separator. In a case where a separator is produced in a manner such that a porous layer is disposed on a polyolefin porous film, the production process involves a drying step to dry the polyolefin porous film and the porous layer, the porous layer having been disposed on the polyolefin porous film via a method such as application of a coating solution. In the drying step, the polyolefin porous film and the porous layer can each undergo shrinkage that occurs along with volatilization of, for example, a solvent. This shrinkage that occurs along with volatilization of, for example, a solvent tends to occur to a greater degree in the porous layer (obtained by a method such as application of a coating solution) than in the polyolefin porous film. The effects of shrinkage of the porous layer may cause the polyolefin porous film to undergo an even greater degree of shrinkage than if the polyolefin porous film were to be dried alone. In a polyolefin porous film having undergone this greater degree of shrinkage, a force is generated which acts to reverse the extra amount of shrinkage; in other words, residual stress occurs. This causes a difference in the amount of stress acting on the porous layer and the amount of stress acting on the polyolefin porous film. When a nonaqueous electrolyte secondary battery is produced with use of a separator, the separator comes into contact with a nonaqueous electrolyte. Presumably, as the nonaqueous electrolyte permeates into the separator, the difference in the amount of stress is mitigated, and thus anisotropy of softening of the separator occurs.

Even in a case where production of a separator does not involve disposing a porous layer on a polyolefin porous film, a difference can occur in the amount of stress acting on the surface the polyolefin porous film and the amount of stress acting on the internal portion of the polyolefin porous film. Furthermore, a difference can occur in the amount of stress acting on the surface the polyolefin porous film and the amount of stress acting on the internal portion of the polyolefin porous film during stretching of the polyolefin porous film. It is therefore presumably possible to reduce anisotropy of deformation occurring after immersion in an electrolyte by controlling the value of (E_{Min24}/E_{MinB})/(E_{Max24}/E_{MaxB}), not just in a laminated separator having a plurality of layers, but also in a separator consisting of only one layer.

In an embodiment of the present invention, the value of (E_{Min24}/E_{MinB})/(E_{Max24}/E_{MaxB}) is calculated, via the above-described method, from (i) tensile elastic moduli as observed in test pieces which have not been immersed in propylene carbonate and (ii) tensile elastic moduli as observed in test pieces which have been immersed in propylene carbonate for 24 hours. Patent Literature 1 discloses that a dimensional change rate is measured after a test piece has been immersed in dimethyl carbonate for 30 minutes. However, the inventors of the present invention discovered that merely measuring a dimensional change rate after 30 minutes of immersion was insufficient for achieving a nonaqueous electrolyte secondary battery separator having reduced anisotropy of deformation. When a separator is immersed in an electrolyte, the electrolyte permeates into pores of the separator, and thereafter gradually begins permeating into the resin of the separator. These phenomena can cause elongation of the separator which occurs after approximately 30 minutes of immersion. After this, once the electrolyte permeates even further into the resin of the separator, elongation can occur in internal portions of the resin of the separator. Elongation of internal portions of the resin of the separator is caused primarily by the above-described residual stress in internal portions of the separator. Such elongation continues to progress even after 30 minutes of immersion in an electrolyte, and progression tends to stop after approximately 24 hours of immersion. For this reason, in order to reduce the anisotropy of deformation of a separator, it is necessary to consider the (E_{Min24}/E_{MinB})/(E_{Max24}/E_{MaxB}) which is determined after 24 hours of electrolyte.

In an embodiment of the present invention, only the value of (E_{Min24}/E_{MinB})/(E_{Max24}/E_{MaxB}) need fall within a specific range. As such, the respective values of E_{MaxB}, E_{MaxB}, E_{Max24}, E_{Min24}, E_{Max24}/E_{MaxB}, and E_{Min24}/E_{MinB} are not particularly limited. For example, E_{MaxB} may be 500.00 MPa to 1500.00 MPa, or may be 600.00 MPa to 1000.00 MPa. E_{MinB} may be 400.00 MPa to 1000.00 MPa, or may be 500.00 MPa to 800.00 MPa. E_{Max24} may be 300.00 MPa to 1300.00 MPa, or may be 400.00 MPa to 900.00 MPa. E_{Min24} may be 200.00 MPa to 800.00 MPa, or may be 300.00 MPa to 600.00 MPa. E_{Max24}/E_{MaxB} may be 0.60 to 1.00, or may be 0.70 to 0.95. E_{Min24}/E_{MinB} may be 0.50 to 1.00, or may be 0.60 to 0.90.

Note that the value of (E_{Min24}/E_{MaxB})/(E_{Max24}/E_{MaxB}) can be similarly controlled, whether in the case of (i) a separator immediately after production, i.e., a separator which has not yet been incorporated into a nonaqueous electrolyte secondary battery, or (ii) a separator which has been removed from a nonaqueous electrolyte secondary battery which has been produced. This is demonstrated in Example 3 (described later). Even in the case of a separator which has been removed from a nonaqueous electrolyte secondary battery, i.e., a separator which has come into contact with an electrolyte, the value of (E_{Min24}/E_{MinB})/(E_{Max24}/E_{MaxB}) can be measured by carrying out the above-described measurement method after drying the separator.

A nonaqueous electrolyte secondary battery separator in accordance with an embodiment of the present invention is more effective in a pouch-type cell than in a cylindrical cell. Because a cylindrical cell has a separator which is small in size, the effects of anisotropy of deformation occurring after immersion in an electrolyte are also presumably small. A separator of a pouch-type cell, however, is large is size, and the effects of anisotropy of deformation occurring after immersion in an electrolyte are therefore presumably great. In a case where a separator is used in a pouch-type cell and is rectangular, a short side of the separator may be not less than 70 mm, or not less than 100 mm. A long side of such a separator may be not more than 500 mm, or not more than 400 mm. In a case where a separator has a shape which is not rectangular, the smallest dimension of that shape may be in a range similar to that of the short side described above, and the largest dimension may be in a range similar to that of the long side described above.

<Polyolefin Porous Film>

Hereinafter, a polyolefin porous film may be referred to simply as a “porous film”. The porous film contains a polyolefin-based resin as a main component and has therein many pores connected to one another, so that a gas and a liquid can pass through the porous film from one surface to the other. The porous film can be used alone as a nonaqueous electrolyte secondary battery separator.

Further, the porous film can be a base material for a nonaqueous electrolyte secondary battery laminated separator in which a porous layer (described later) is provided. A laminated body including the porous layer disposed on at least one surface of the polyolefin porous film is herein referred to as “nonaqueous electrolyte secondary battery laminated separator” or “laminated separator.” The nonaqueous electrolyte secondary battery laminated separator can also be described as including a nonaqueous electrolyte secondary battery separator and a porous layer. A nonaqueous electrolyte secondary battery separator for an embodiment of the present invention may further include another layer(s) such as an adhesive layer, a heat-resistant layer, a protective layer, and/or the like, in addition to the polyolefin porous film.

The porous film contains polyolefin in a proportion of not less than 50% by volume, preferably not less than 90% by volume, and more preferably not less than 95% by volume, relative to the entire porous film. The polyolefin more preferably contains a high molecular weight component having a weight-average molecular weight of 5×10⁵ to 15×10⁶. In particular, the polyolefin more preferably contains a high molecular weight component having a weight-average molecular weight of not less than 1,000,000 because such a high molecular weight component improves the strength of a resultant nonaqueous electrolyte secondary battery separator.

Examples of the polyolefin which is a thermoplastic resin include homopolymers and copolymers which are each obtained by polymerizing a monomer(s) such as ethylene, propylene, 1-butene, 4-methyl-1-pentene, 1-hexene, and/or the like. Specifically, examples of such homopolymers include polyethylene, polypropylene, and polybutene. Examples of such copolymers include an ethylene-propylene copolymer.

Among the above examples of polyolefin, polyethylene is more preferable because use of polyethylene makes it possible to prevent a flow of an excessively large electric current at a lower temperature. Preventing the flow of an excessively large electric current is also called “shutdown.” Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is further preferable.

The porous film has a thickness of preferably 4 μm to 40 μm, more preferably 5 μm to 30 μm, and still more preferably 6 μm to 15 μm.

A weight per unit area of the porous film can be set as appropriate in view of the strength, thickness, weight, and handleability of the porous film. Note, however, that the weight per unit area of the porous film is preferably 4 g/m² to 20 g/m², more preferably 4 g/m² to 12 g/m², and still more preferably 5 g/m² to 10 g/m², so as to allow the nonaqueous electrolyte secondary battery to have a higher weight energy density and a higher volume energy density.

The porous film has an air permeability of preferably 30 sec/100 mL to 500 sec/100 mL, and more preferably 50 sec/100 mL to 300 sec/100 mL, in terms of Gurley values. A porous film having the above air permeability can achieve sufficient ion permeability.

The porous film has a porosity of preferably 20% by volume to 80% by volume, and more preferably 30% by volume to 75% by volume, so as to (i) retain an electrolyte in a larger amount and (ii) obtain a function of reliably preventing a flow of an excessively large electric current at a lower temperature. Further, in order to achieve sufficient ion permeability and prevent particles from entering the positive electrode and/or the negative electrode, the porous film has pores each having a pore size of preferably not more than 0.3 μm, and more preferably not more than 0.14 μm.

<Porous Layer>

In an embodiment of the present invention, the porous layer, as a member included in a nonaqueous electrolyte secondary battery, can be provided between (i) the polyolefin porous film and (ii) at least one of the positive electrode and the negative electrode. The porous layer can be provided on one surface of the polyolefin porous film or on both surfaces of the polyolefin porous film. Alternatively, the porous layer can be provided on an active material layer of at least one of the positive electrode and the negative electrode.

Alternatively, the porous layer can be provided between (i) the polyolefin porous film and (ii) at least one of the positive electrode and the negative electrode, in a manner so as to be in contact with the polyolefin porous film and the at least one of the positive electrode and the negative electrode. The number of porous layer(s) provided between (i) the polyolefin porous film and (ii) at least one of the positive electrode and the negative electrode can be one, two, or more. The porous layer is preferably an insulating porous layer containing a resin.

In a case where the porous layer is disposed on one surface of the polyolefin porous film, the porous layer is preferably disposed on a surface of the polyolefin porous film which surface faces the positive electrode. The porous layer is more preferably disposed on a surface which makes contact with the positive electrode.

Examples of the resin constituting the porous layer include polyolefins; (meth)acrylate-based resins; fluorine-containing resins; polyamide-based resins; polyimide-based resins; polyester-based resins; rubbers; resins each having a melting point or a glass transition temperature of not lower than 180° C.; water-soluble polymers; polycarbonate, polyacetal, and polyether ether ketone.

Of the above resins, polyester-based resins, (meth)acrylate-based resins, fluorine-containing resins, polyamide-based resins, polyimide-based resins, and water-soluble polymers are preferable.

The polyolefins are preferably polyethylene, polypropylene, polybutene, an ethylene-propylene copolymer, and the like.

Examples of the fluorine-containing resins encompass polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetraflu or oethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins encompass fluorine-containing rubber having a glass transition temperature of not higher than 23° C.

As the polyamide-based resins, aramid resins such as aromatic polyamides and wholly aromatic polyamides are preferable.

Examples of the aramid resins include para-aramids and meta-aramids. Among these, para-aramids are more preferable. Examples of the para-aramids encompass para-aramids each having a para-oriented structure or a quasi-para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and a paraphenylene terephthalamide/2,6-dichloroparaphenylene terephthalamide copolymer. Examples of the meta-aramids encompass poly(metaphenylene isophthalamide), poly(metabenzamide), poly(metaphenylene-4,4′-biphenylene dicarboxylic acid amide), poly(metaphenylene-2,6-naphthalene dicarboxylic acid amide), and a metaphenylene terephthalamide/2,6-dichloroparaphenylene terephthalamide copolymer. Among the above examples, poly(paraphenylene terephthalamide) is more preferable.

The polyester-based resins are preferably aromatic polyesters such as polyarylates, and liquid crystal polyesters.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

Each of these resins used in the porous layer can be used solely. Alternatively, two or more of these resins contained in the porous layer can be used in combination.

The porous layer may contain a filler. The filler may be an inorganic filler or an organic filler. An inorganic filler made of an inorganic oxide such as silica, calcium oxide, magnesium oxide, titanium oxide, alumina, mica, zeolite, aluminum hydroxide, or boehmite is more preferable. An amount of filler contained in the porous layer may be 10 weight % to 99 weight %, and may be 20 weight % to 75 weight %, with respect to a total amount of the resin and the filler.

In particular, in a case where the resin used for the porous layer is an aramid resin, controlling the amount of filler contained so as to fall in the above-described range of 20 weight % to 75 weight % makes it possible to control an increase in the weight of the separator due to the filler, and also makes it possible to obtain a separator having favorable ion permeability.

In an embodiment of the present invention, the porous layer is preferably provided between the polyolefin porous film and a positive electrode active material layer of the positive electrode. The descriptions below of the physical properties of the porous layer describe at least the physical properties of a porous layer disposed between the polyolefin porous film and the positive electrode active material layer of the positive electrode in a nonaqueous electrolyte secondary battery.

The porous layer has an average thickness of preferably 0.5 μm to 10 μm per layer (per porous layer), and more preferably 1 μm to 5 μm per layer (per porous layer) in order to ensure adhesion of the porous layer to an electrode and a high energy density. The porous layer having a thickness of not less than 0.5 μm per layer makes it possible to sufficiently prevent an internal short circuit caused by, for example, damage to the nonaqueous electrolyte secondary battery, and also to retain a sufficient amount of the electrolyte in the porous layer. In a case where the thickness of the porous layer is greater than 10 μm per layer, resistance to lithium ion permeation increases in the nonaqueous electrolyte secondary battery. This can cause the positive electrode to deteriorate along with repeated cycles. As a result, the nonaqueous electrolyte secondary battery may suffer a deterioration in a rate characteristic and cycle characteristic. Further, such a porous layer increases the distance between the positive electrode and the negative electrode. This can lead to a decreased internal volume efficiency of the nonaqueous electrolyte secondary battery.

A weight per unit area of the porous layer can be set as appropriate in view of the strength, thickness, weight, and handleability of the porous layer. The weight per unit area of the porous layer is preferably 0.5 g/m² to 20 g/m² per layer (per porous layer) and more preferably 0.5 g/m² to 10 g/m² per layer (per porous layer). A porous layer having a weight per unit area within the above numerical ranges allows a nonaqueous electrolyte secondary battery including the porous layer to have a higher weight energy density and a higher volume energy density. A porous layer whose weight per unit area exceeds the above ranges tends to cause a nonaqueous electrolyte secondary battery to be heavy.

The porous layer has a porosity of preferably 20% by volume to 90% by volume, and more preferably 30% by volume to 80% by volume, in order to achieve sufficient ion permeability. The pores in the porous layer have a diameter of preferably not more than 1.0 μm, and more preferably not more than 0.5 μm. In a case where the pores each have such a diameter, a nonaqueous electrolyte secondary battery that includes the porous layer can achieve sufficient ion permeability.

A nonaqueous electrolyte secondary battery laminated separator including the porous layer disposed on the porous film has an air permeability of preferably 30 sec/100 mL to 1000 sec/100 mL, and more preferably 50 sec/100 mL to 800 sec/100 mL, in terms of Gurley values. The nonaqueous electrolyte secondary battery laminated separator which has an air permeability falling within the above range allows the nonaqueous electrolyte secondary battery to achieve sufficient ion permeability.

[2. Method of Producing Nonaqueous Electrolyte Secondary Battery Separator]

A method in accordance with an embodiment of the present invention is a method of producing a nonaqueous electrolyte secondary battery separator including a polyolefin porous film, the method including: a drying step in which a separator original sheet including the polyolefin porous film is dried in at least two stages, each of the at least two stages having a respective temperature which is set such that at least two differing temperatures are utilized in the drying step, the at least two stages of the drying step including a stage in which the separator original sheet is heated at a temperature which is not less than 116° C. and not more than 130° C. The term “separator original sheet” as used herein refers to a separator which has not yet been cut and which is long and wide. The separator original sheet can include a polyolefin porous film. A porous layer may be disposed on the polyolefin porous film.

<Method of Producing Polyolefin Porous Film>

A method of producing the porous film is not particularly limited. For example, the polyolefin porous film can be produced by a method as follows. First, polyolefin-based resin is kneaded together with a pore forming agent such as an inorganic bulking agent or a plasticizer, and optionally with another agent(s) such as an antioxidant. After kneading, the kneaded substances are extruded so as to produce a polyolefin resin composition in sheet form. The pore forming agent is then removed from the polyolefin resin composition in sheet form with use of a suitable solvent. After the pore forming agent is removed, the polyolefin resin composition is stretched so that a polyolefin porous film is obtained.

The inorganic bulking agent is not particularly limited. Examples of the inorganic bulking agent include inorganic fillers; one specific example is calcium carbonate. Examples of the plasticizer include, but are not particularly limited to, a low molecular weight hydrocarbon such as liquid paraffin.

As a more specific example of a method for producing the porous film, a method including the following steps may be used.

(A) Obtaining a polyolefin resin composition by kneading ultra-high molecular weight polyethylene, low molecular weight polyethylene having a weight-average molecular weight of not more than 10,000, a pore forming agent such as calcium carbonate or a plasticizer, and an antioxidant;
(B) Forming a sheet by (i) rolling the polyolefin resin composition with use of a pair of reduction rollers and (ii) cooling the polyolefin resin composition in stages while tensioning the polyolefin resin composition with use of a take-up roller whose velocity ratio differs from that of the reduction rollers;
(C) Removing the pore forming agent from the sheet with use of a suitable solvent; and
(D) Stretching the sheet, from which the pore forming agent has been removed, with use of a suitable stretch ratio.

<Method of Producing Porous Layer>

The porous layer can be formed with use of a coating solution which is obtained by (i) dissolving or dispersing resin in a solvent and (ii) dispersing a filler in the solvent. The solvent can be described as being a solvent which the resin is dissolved and also a dispersion medium in which the resin or filler is dispersed. Examples of a method for forming the coating solution include a mechanical stirring method, an ultrasonic dispersion method, a high-pressure dispersion method, and a media dispersion method.

The porous layer can be formed by, for example, (i) a method of applying the coating solution directly to a surface of a base material and then removing the solvent, (ii) a method of applying the coating solution to an appropriate support, subsequently removing the solvent so as to form a porous layer, pressure-bonding the porous layer to the base material, and peeling the support off, (iii) a method of applying the coating solution to a surface of an appropriate support, pressure-bonding the base material to that surface, peeling the support off, and then removing the solvent, or (iv) a method of carrying out dip coating by immersing the base material into the coating solution, and then removing the solvent.

The solvent preferably (i) does not have an adverse effect on the base material, (ii) allows the resin to be uniformly and stably dissolved in the solvent, and (iii) allows the filler to be uniformly and stably dispersed in the solvent. Examples of the solvent include N-methyl-2-pyrrolidone, N,N-dimethylacetamide, N,N-dimethylformamide, acetone, and water.

As necessary, the coating solution may contain, as a component(s) other than the resin and the filler, for example, a dispersing agent, a plasticizer, a surfactant, and/or a pH adjusting agent.

Examples of the base material other than the polyolefin porous film include a film other than the polyolefin porous film, a positive electrode, and a negative electrode.

The coating solution can be applied to the base material by a conventionally known method. Specific examples of such a method include a gravure coater method, a dip coater method, a bar coater method, and a die coater method.

In a case where the coating solution includes an aramid resin, the aramid resin can be deposited by applying humidity (i.e., moisture) to the surface on which the coating solution is applied. The porous layer can be formed in this way.

Examples of a method of preparing the aramid resin encompass, but are not particularly limited to, condensation polymerization of para-oriented aromatic diamine and para-oriented aromatic dicarboxylic acid halide. In such a case, the aramid resin obtained is substantially composed of repeating units in which amide bonds occur at para or quasi-para positions of the aromatic ring. “Quasi-para positions” refers to positions at which bonds extend in opposing directions from each other, coaxially or in parallel, as in the case of, for example, 4,4′-biphenylene, 1,5-naphthalene, and 2,6-naphthalene.

A solution of poly(paraphenylene terephthalamide) can be prepared by, for example, a method including the following specific steps (1) through (4).

(1) N-methyl-2-pyrrolidone is introduced into a dried flask. Then, calcium chloride which has been dried at 200° C. for 2 hours is added. Then, the flask is heated to 100° C. to completely dissolve the calcium chloride.
(2) The solution obtained in the step (1) is returned to room temperature, and then paraphenylenediamine is added and completely dissolved.
(3) While a temperature of the solution obtained in the step (2) is maintained at 20±2° C., terephthalic acid dichloride is added, the terephthalic acid dichloride being divided into 10 separate identical portions added at approximately 5-minute intervals.
(4) While a temperature of the solution obtained in the step (3) is maintained at 20±2° C., the solution is matured for 1 hour, and is then stirred under reduced pressure for 30 minutes to eliminate air bubbles, so that the solution of the poly(paraphenylene terephthalamide) is obtained.

<Drying Step>

A method of producing a nonaqueous electrolyte secondary battery separator in accordance with an embodiment of the present invention includes a drying step in which a separator original sheet is dried in at least two stages, each of the at least two stages having a respective temperature which is set such that at least two differing temperatures are utilized in the drying step. In a case where the separator original sheet is a porous film on which a porous layer is disposed, this drying step involving at least two stages makes it possible to dry the porous layer and the porous film in a manner so as to reduce residual stress occurring in the porous film, as described below. Note that, out of the at least two stages of the drying step, a stage which is carried out further upstream in the conveying direction of the separator original sheet is referred to as an “earlier stage”, and a stage which is carried out further downstream is referred to as a “later stage”.

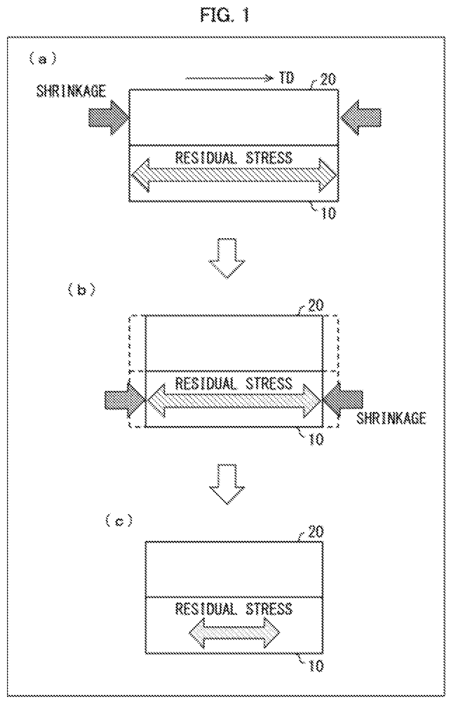

FIG. 1 is a diagram schematically illustrating shrinkage of a porous film 10 and a porous layer 20 caused by drying. As illustrated in (a) of FIG. 1, in the earlier stage of the drying step, the porous layer 20 is prone to shrinkage occurring along with vaporization of a solvent. Residual stress is generated in the porous film 10 due to the effects of the shrinkage of the porous layer 20. Presumably, a large amount of this residual stress is generated primarily in the transverse direction. Next, as illustrated in (b) of FIG. 1, further heating carried out in the later stage of the drying step causes the porous film 10 to shrink. This makes it possible to reduce a difference in the amount of stress acting on the porous layer 20 and the amount of stress acting on the porous film 10. As a result, residual stress is reduced in the porous film 10, as illustrated in (c) of FIG. 1. It is therefore possible to reduce anisotropy of deformation that occurs when the separator comes into contact with an electrolyte. Note that even in the case of a separator original sheet consisting of a single layer of the porous film, the drying step involving at least two stages makes it possible to reduce a difference in the amount of stress acting on the surface and the amount of stress acting on the internal portions of the porous film.

In an embodiment of the present invention, the at least two stages of the drying step include a stage in which the separator original sheet is heated at a temperature which is not less than 116° C. and not more than 130° C. Setting the heating temperature to be not less than 116° C. causes the porous film to shrink sufficiently and, as a result, makes it possible to reduce a difference in the amount of stress. Setting the heating temperature to be not more than 130° C. makes it possible to avoid adversely affecting the properties of the separator. In terms of reducing the anisotropy of deformation, the heating temperature is more preferably not less than 120° C. and not more than 130° C.

Note that using a higher temperature in the later stage of the drying step than in the earlier stage of the drying step makes it possible to dry the base material even more effectively. In such a case, it is preferable to carry out the later stage of the drying step at a temperature in the above-mentioned ranges. More preferably, a stage of the drying step which utilizes heating at the above temperature range is a stage which is carried out furthest downstream.

For example, the drying step preferably includes (i) a stage in which heating is carried out at a temperature of not less than 100° C. and not more than 115° C., and (ii) a subsequent stage in which heating is carried out at a temperature of not less than 116° C. and not more than 130° C.

The production method preferably includes a drying step involving at least three stages, each of the at least three stages having a respective temperature which is set such that at least three differing temperatures are utilized in the drying step. In such a case, it is preferable that the heating temperature is higher in a stage further downstream as compared to a stage further upstream. Such a configuration makes it possible to dry the porous film after having more sufficiently dried the porous layer. In a case where the production method includes a drying step involving at least three stages, out of the at least three stages, a stage carried out on an upstream side preferably uses a heating temperature of not less than 50° C. and not more than 99° C. A subsequent stage of the drying step preferably uses a heating temperature of not less than 100° C. and not more than 115° C. A more subsequent stage of the drying step preferably uses a heating temperature of not less than 116° C. and not more than 130° C.

The drying may be carried out via, for example, roller heating. Roller heating involves drying a separator original sheet by causing the separator original sheet to contact a heated roller. The roller can be heated by, for example, supplying at heating medium into the roller and circulating the heating medium within the roller. In such a case, the above-described heating temperatures indicate the temperature of the heating medium. It is possible to achieve differing heating temperatures in an earlier stage and a later stage of the drying step by using differing types of heating media at each stage. Possible examples of the heating media include heated water, oil, and steam. For example, heated water may be supplied to a lower-temperature roller, and steam may be supplied to a higher-temperature roller.

[3. Nonaqueous Electrolyte Secondary Battery Member, Nonaqueous Electrolyte Secondary Battery]

A nonaqueous electrolyte secondary battery member in accordance with an embodiment of the present invention includes: a positive electrode; the above-described nonaqueous electrolyte secondary battery separator or nonaqueous electrolyte secondary battery laminated separator; and a negative electrode, the positive electrode, the nonaqueous electrolyte secondary battery separator or nonaqueous electrolyte secondary battery laminated separator, and the negative electrode being arranged in this order. A nonaqueous electrolyte secondary battery in accordance with an embodiment of the present invention includes the above-described nonaqueous electrolyte secondary battery separator or nonaqueous electrolyte secondary battery laminated separator.

The nonaqueous electrolyte secondary battery in accordance with an embodiment of the present invention can be produced by a publicly known conventional method. As one example, first, a nonaqueous electrolyte secondary battery member is formed by providing a positive electrode, the polyolefin porous film, and a negative electrode in this order. The porous layer can be provided between the polyolefin porous film and at least one of the positive electrode and the negative electrode. Next, the nonaqueous electrolyte secondary battery member is inserted into a container which serves as a housing for the nonaqueous electrolyte secondary battery. The container is then filled with the above-described nonaqueous electrolyte, and then hermetically sealed while pressure is reduced in the container. In this way, the nonaqueous electrolyte secondary battery in accordance with an embodiment of the present invention can be produced.

<Positive Electrode>

The positive electrode employed in an embodiment of the present invention is not limited to any particular one, provided that the positive electrode is one that is generally used as a positive electrode of a nonaqueous electrolyte secondary battery. Examples of the positive electrode include a positive electrode sheet having a structure in which an active material layer, containing a positive electrode active material and a binding agent, is formed on a positive electrode current collector. The active material layer may further contain an electrically conductive agent.

Examples of the positive electrode active material include materials each capable of being doped with and dedoped of metal ions such as lithium ions or sodium ions. Specific examples of the materials include lithium complex oxides each containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and a fired product of an organic polymer compound. Each of these electrically conductive agents can be used solely. Alternatively, two or more of these electrically conductive agents can be used in combination.

Examples of the binding agent include: fluorine-based resins such as polyvinylidene fluoride (PVDF); acrylic resin; and styrene butadiene rubber. Note that the binding agent serves also as a thickener.

Examples of the current collector included in the positive electrode (i.e., positive electrode current collector) include electric conductors such as Al, Ni, and stainless steel. Of these electric conductors, Al is more preferable because Al is easily processed into a thin film and is inexpensive.

Examples of a method for producing the positive electrode sheet include: a method in which the positive electrode active material, the electrically conductive agent, and the binding agent are pressure-molded on the positive electrode current collector; and a method in which (i) the positive electrode active material, the electrically conductive agent, and the binding agent are formed into a paste with use of an appropriate organic solvent, (ii) the positive electrode current collector is coated with the paste, and (iii) the paste is dried and then pressured so that the paste is firmly fixed to the positive electrode current collector.

<Negative Electrode>

The negative electrode employed in an embodiment of the present invention is not limited to any particular one, provided that the negative electrode is one that is generally used as a negative electrode of a nonaqueous electrolyte secondary battery. Examples of the negative electrode include a negative electrode sheet having a structure in which an active material layer, containing a negative electrode active material and a binding agent, is formed on a negative electrode current collector. The active material layer may further contain an electrically conductive agent.

Examples of the negative electrode active material include materials each capable of being doped with and dedoped of metal ions such as lithium ions or sodium ions. Examples of the materials include carbonaceous materials. Examples of the carbonaceous materials include natural graphite, artificial graphite, cokes, carbon black, and pyrolytic carbons.

Examples of the current collector included in the negative electrode (i.e., negative electrode current collector) include Cu, Ni, and stainless steel. Of these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressure is applied so that the paste is firmly fixed to the negative electrode current collector. The paste preferably contains an electrically conductive agent as described above and a binding agent as described above.

<Nonaqueous Electrolyte>

A nonaqueous electrolyte for an embodiment of the present invention is not limited to any particular one, provided that the nonaqueous electrolyte is one that is generally used for a nonaqueous electrolyte secondary battery. The nonaqueous electrolyte can be, for example, a nonaqueous electrolyte containing an organic solvent and a lithium salt dissolved therein. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. Each of these lithium salts can be used solely. Alternatively, two or more of these lithium salts can be used in combination.

Examples of the organic solvent to be contained in the nonaqueous electrolyte include carbonates, ethers, esters, nitriles, amides, carbamates, sulfur-containing compounds, and fluorine-containing organic solvents each obtained by introducing a fluorine group into any of these organic solvents. Each of these organic solvents can be used solely. Alternatively, two or more of these organic solvents can be used in combination.

### EXAMPLES

The present invention will be described below in more detail with reference to Examples and Comparative Examples. Note, however, that the present invention is not limited to such Examples.

[Measurement Methods]

The methods used for various measurements in the Examples and Comparative Example are as follows.

<Tensile Elastic Modulus>

(1) Tensile Elastic Modulus Before Immersion

From each sheet-type laminated separator obtained in the Examples and Comparative Examples (described later), a test piece 1 was cut out so as to be rectangular in shape and measure 15 mm by 50 mm. Note that the test piece 1 was prepared such that the sides of the test piece 1 were parallel to the respective sides of the sheet-type laminated separator. The same applies to the other test pieces described below. A tension test device (Tensilon Universal Material Testing Instrument RTG-1310, manufactured by A&D Company, Limited) was used to carry out a tension test on test piece 1 with respect to the longitudinal direction. Test conditions were: temperature: 23° C.; chuck-to-chuck distance: 30 mm; and pulling speed: 50 mm/s. The tensile elastic modulus was then calculated from the slope of the resulting stress-strain curve in a range where stress was 1 MPa to 5 MPa. Measurement was carried out twice for each Example and Comparative Example subject to measurement. The tensile elastic moduli respectively calculated from the two measurements were averaged, and the average value was used as the tensile elastic modulus of the test piece 1.

Next, from each of the sheet-type laminated separators of the Examples and Comparative Examples, a test piece 2 was cut out so as to measure 50 mm in a direction in which the test piece 1 measured 15 mm, and 15 mm in a direction in which the test piece 1 measured 50 mm. In other words, the test piece 2 was produced so that, in terms of orientation with respect to the laminated separator, the longitudinal direction of the test piece 2 was perpendicular to the longitudinal direction of test piece 1. The tensile elastic modulus of the test piece 2 was determined by carrying out a tension test in the same manner as for the test piece 1.

The high tensile elastic modulus direction before immersion in electrolyte was determined to be the longitudinal direction of whichever of the test piece 1 and test piece 2 had a higher tensile elastic modulus. Likewise, the low tensile elastic modulus direction before immersion in electrolyte was determined to be the longitudinal direction of whichever of the test piece 1 and test piece 2 had a lower tensile elastic modulus.

(2) Tensile Elastic Modulus after Immersion

A piece of laminated separator was cut so as to have a size of 50 mm by 100 mm. This piece was placed in a 500 mL plastic container having a lid, and then propylene carbonate was introduced into the plastic container. The propylene carbonate was introduced in an amount such that the piece of the laminated separator was completely submerged in liquid. The plastic container was then sealed and left to stand in an environment whose temperature was 23° C. After minutes, the piece of the laminated separator was removed from the plastic container and the surfaces of the piece were wiped so as to remove excess propylene carbonate therefrom. Then, from this piece of the laminated separator which was immersed as above, a test piece 3 was cut so as to have a size of 15 mm by 50 mm. A tension test device (Tensilon Universal Material Testing Instrument RTG-1310, manufactured by A&D Company, Limited) was used to carry out a tension test on test piece 3 with respect to the longitudinal direction. Test conditions were: temperature: 23° C.; chuck-to-chuck distance: 30 mm; and pulling speed: 50 mm/s. The tensile elastic modulus was then calculated from the slope of the resulting stress-strain curve in a range where stress was 1 MPa to 5 MPa. Measurement was carried out twice for each Example and Comparative Example subject to measurement. The tensile elastic moduli respectively calculated from the two measurements were averaged, and the average value was used as the tensile elastic modulus of the test piece 3.

Next, from the piece of the laminated separator which was immersed as above, a test piece 4 was cut out so as to measure 50 mm in a direction in which the test piece 3 measured 15 mm, and 15 mm in a direction in which the test piece 3 measured 50 mm. In other words, the test piece 4 was produced so that, in terms of orientation with respect to the laminated separator, the longitudinal direction of the test piece 4 was perpendicular to the longitudinal direction of test piece 3. The tensile elastic modulus of the test piece 4 was determined by carrying out a tension test in the same manner as for the test piece 3.

The high tensile elastic modulus direction after 30 minutes of immersion in electrolyte was determined to be the longitudinal direction of whichever of the test piece 3 and test piece 4 had a higher tensile elastic modulus. Likewise, the low tensile elastic modulus direction after 30 minutes of immersion in electrolyte was determined to be the longitudinal direction of whichever of the test piece 3 and test piece 4 had a lower tensile elastic modulus.

Tensile elastic moduli after 24 hours of immersion were measured in the same manner as above, except that the time of immersion in the propylene carbonate was changed to 24 hours.

(3) Tensile Elastic Modulus after Immersion, Cleaning, and Drying

A piece of laminated separator was cut so as to have a size of 50 mm by 100 mm. This piece was placed in a 500 mL plastic container having a lid, and then propylene carbonate was introduced into the plastic container. The propylene carbonate was introduced in an amount such that the piece of the laminated separator was completely submerged in liquid. The plastic container was then sealed and left to stand in an environment whose temperature was 23° C. After 24 hours, the piece of the laminated separator was removed from the plastic container and the surfaces of the piece were wiped so as to remove excess propylene carbonate therefrom. Next, the piece of the laminated separator was placed in a 500 mL plastic container having a lid, and then ethanol was introduced into the plastic container. The ethanol was introduced in an amount such that the piece of the laminated separator was completely submerged in liquid. After 1 hour, the piece of the laminated separator was removed from the plastic container and further cleaned with ethanol. The piece of the laminated separator was then spread out onto a glass plate and dried for 48 hours in an atmosphere having a temperature of 23° C.

Then, from the piece of the laminated separator which was dried as above, a test piece 5 was cut so as to have a size of 15 mm by 50 mm. A tension test device (Tensilon Universal Material Testing Instrument RTG-1310, manufactured by A&D Company, Limited) was used to carry out a tension test on test piece 5 with respect to the longitudinal direction. Test conditions were: temperature: 23° C.; chuck-to-chuck distance: 30 mm; and pulling speed: 50 mm/s. The tensile elastic modulus was then calculated from the slope of the resulting stress-strain curve in a range where stress was 1 MPa to 5 MPa. Measurement was carried out twice for each Example subject to measurement (Example 3). The tensile elastic moduli respectively calculated from the two measurements were averaged, and the average value was used as the tensile elastic modulus of the test piece 5.

Next, from the piece of the laminated separator which was dried as above, a test piece 6 was cut out so as to measure 50 mm in a direction in which the test piece 5 measured 15 mm, and 15 mm in a direction in which the test piece 5 measured 50 mm. In other words, the test piece 6 was produced so that, in terms of orientation with respect to the laminated separator, the longitudinal direction of the test piece 6 was perpendicular to the longitudinal direction of test piece 5. The tensile elastic modulus of the test piece 6 was determined by carrying out a tension test in the same manner as for the test piece 5.

The high tensile elastic modulus direction after drying was determined to be the longitudinal direction of whichever of the test piece 5 and test piece 6 had a higher tensile elastic modulus. Likewise, the low tensile elastic modulus direction after drying was determined to be the longitudinal direction of whichever of the test piece 5 and test piece 6 had a lower tensile elastic modulus.

(4) Tensile Elastic Modulus after Immersion, Cleaning, Drying, and Second Immersion

A separator was subjected to the steps described in “(3) Tensile elastic modulus after immersion, cleaning, and drying,” up to and including the drying. Thereafter, the separator thus dried was subjected to the immersion and tension test as described in “(2) Tensile elastic modulus after immersion,” so as determine the tensile elastic moduli thereof.

<Elongation Amount Evaluation>

From each laminated separator obtained in the Examples and Comparative Examples (described later), a test piece 7 was cut out so as to measure 250 mm in length and 20 mm in width. The test piece 7 was placed in a 500 mL plastic container having a lid, and then propylene carbonate was introduced into the plastic container. The propylene carbonate was introduced in an amount such that the test piece 7 was completely submerged in liquid. The plastic container was then sealed and left to stand in an environment whose temperature was 23° C. After 30 minutes, the test piece 7 was removed from the plastic container and carefully spread out onto a glass plate (measuring 300 mm in length, 220 mm in width, and 15 mm in thickness) so as not to create wrinkles. Another glass plate of the same size was placed on top of the test piece 7 so as to be fully in contact with the test piece 7. The elongation amount in the longitudinal direction of the test piece 7 was then measured through the glass plates. A 30 cm stainless steel ruler (“S-30”, manufactured by Lion Office Products Corp.) was used to measure the elongation amount. During measurements, marks on the ruler were magnified with use of a magnifying glass. Note that the elongation amount measurements were carried out within 3 minutes of removing the test piece 7 from the plastic container. After the measurement, the test piece 7 was placed back into the plastic container, and similar measurements were made again after 24 hours. Note that measurements of the elongation amount were carried out three times for each sample, and the values of the three measurements were averaged to obtain an average elongation amount.

Next, from the laminated separator from which the test piece 7 was cut, a test piece 8 was cut out so as to measure 20 mm in a direction in which the test piece 7 measured 250 mm, and 250 mm in a direction in which the test piece 7 measured 20 mm. In other words, the test piece 8 was produced so that, in terms of orientation with respect to the laminated separator, the longitudinal direction of the test piece 8 was perpendicular to the longitudinal direction of test piece 7. The average elongation amount of the test piece 8 was determined by carrying out measurement in the same manner as for test piece 7.

A “direction of high average elongation amount” was determined to be the longitudinal direction of whichever of the test piece 7 and test piece 8 had a higher average elongation amount. Likewise, a “direction of low average elongation amount” was determined to be the longitudinal direction of whichever of the test piece 7 and test piece 8 had a lower average elongation amount.

An elongation amount ratio was then calculated from the following formula.

(elongation amount ratio)=(average elongation amount in direction of high average elongation amount)/(average elongation amount in direction of low average elongation amount)

This elongation amount ratio indicates anisotropy of elongation amount (described later). In other words, the elongation amount ratio indicates the anisotropy of deformation of a separator which deformation occurs after immersion in an electrolyte.

### Example 1

<Preparation of Coating Solution>

Poly(paraphenylene terephthalamide) was produced with use of a 3 L separable flask having a stirring blade, a thermometer, a nitrogen inflow tube, and a powder addition port. Hereinafter, poly(paraphenylene terephthalamide) may also be referred to as “PPTA”. After the flask was dried sufficiently, 2200 g of N-methyl-2-pyrrolidone (NMP) was introduced into the flask. Thereafter, 151.07 g of calcium chloride powder, which had been dried at 200° C. for 2 hours, was added. The flask was then heated to 100° C. so that the calcium chloride powder was completely dissolved and a solution was obtained. The solution was returned to room temperature, and then 68.23 g of paraphenylenediamine was added and completely dissolved. While a temperature of the solution was maintained at 20±2° C., 124.97 g of terephthalic acid dichloride was added, the terephthalic acid dichloride being divided into 10 separate identical portions which were added at approximately 5-minute intervals. The solution was then matured by stirring the solution for 1 hour while maintaining a temperature of 20±2° C. A resultant solution was filtered through a 1500-mesh stainless steel gauze. After filtration, the solution had a PPTA concentration of 6 weight %.

Then, 100 g of the PPTA solution obtained as above was weighed out into a flask. Further, 300 g of NMP was added to the flask so as to obtain a solution whose PPTA concentration was 1.5 weight %. This solution was stirred for 60 minutes. Next, 6 g of Alumina C (manufactured by Nippon Aerosil Co., Ltd.) and 6 g of Advanced Alumina AA-03 (manufactured by Sumitomo Chemical Co., Ltd.) were added to the solution whose PPTA concentration was 1.5 weight %, and stirring was carried out for 240 minutes. A resultant solution was filtered through a 1000-mesh metal gauze. Thereafter, 0.73 g of calcium oxide was added, followed by 240 minutes of stirring to achieve neutralization. A resultant solution was then defoamed under reduced pressure, so that a coating solution slurry was obtained.

<Preparation of Separator>

The coating solution slurry was continuously coated onto a polyethylene porous film measuring 10.2 μm in thickness. A coating film thus formed was then brought into an atmosphere having a temperature 50° C. and a relative humidity of 70%, so that the PPTA was deposited. Next, the coating film from which the PPTA was deposited was rinsed with water so as to remove the calcium chloride and the solvent. Thereafter, the coating film was continuously dried with use of a heating roller group 1 at a temperature of 88° C., and a heating roller group 2. In this way, a laminated separator roll was produced. Note here that, for convenience, an earlier stage roller group is referred to as “heating roller group 1”, and a later stage roller group is referred to as “heating roller group 2”. An earlier stage half of rollers in the heating roller group 2 had a temperature which differed from a later stage half of rollers in the heating roller group 2. Note that the “earlier stage half of rollers” refers to an upstream half of the heating roller group 2, and the “later stage half of rollers” refers to a downstream half of the heating roller group 2. The earlier stage half of rollers of the heating roller group 2 had a temperature of 108° C., and the later stage half of rollers of the heating roller group 2 had a temperature of 126° C. From the laminated separator roll, a sheet-type laminated separator was cut out such that the sides of the sheet-type laminated separator were parallel to the respective sides of the laminated separator roll. A sheet-type laminated separator was also cut out in a similar manner in the other Examples and Comparative Examples. The laminated separator obtained had a thickness of 14.6 μm and an air permeability of 279.9 sec/100 mL. An amount of filler in the porous layer was 66 weight %.

### Example 2

A laminated separator roll was produced in a manner similar to Example 1, except that (i) a polyethylene porous film having a thickness of 10.4 μm was used as the base material, and (ii) the later stage half of rollers of the heating roller group 2 had a temperature of 125° C. The laminated separator of the laminated separator roll thus produced had a thickness of 12.7 μm and an air permeability of 234.5 sec/100 mL.

### Comparative Example 1

A laminated separator roll was produced in a manner similar to Example 1, except that the later stage half of rollers of the heating roller group 2 had a temperature of 110° C. The laminated separator of the laminated separator roll thus produced had a thickness of 14.5 μm and an air permeability of 270.3 sec/100 mL.

### Comparative Example 2

A laminated separator roll was produced in a manner similar to Example 2, except that the later stage half of rollers of the heating roller group 2 had a temperature of 114° C. The laminated separator of the laminated separator roll thus produced had a thickness of 12.4 μm and an air permeability of 224.4 sec/100 mL.

### Example 3

A laminated separator roll was produced in a manner similar to Example 1, except that (i) a polyethylene porous film having a thickness of 9.5 μm was used as the base material, and (ii) the later stage half of rollers of the heating roller group 2 had a temperature of 127° C. The laminated separator of the laminated separator roll thus produced had a thickness of 14.5 μm and an air permeability of 364.1 sec/100 mL.

For this laminated separator, the measurement results of “(3) Tensile elastic modulus after immersion, cleaning, and drying” were used as E_{MaxB} and E_{MinB}, and the measurement results of “(4) Tensile elastic modulus after immersion, cleaning, drying, and second immersion” were used as E_{Max24} and E_{Min24}. Furthermore, the elongation amount of the laminated separator was evaluated after subjecting the laminated separator to the steps described in “(4) Tensile elastic modulus after immersion, cleaning, drying, and second immersion,” up to and including the second immersion.

[Results]

Tables 1 to 4 below show the results of evaluations of the Examples and Comparative Examples.

TABLE 1

| | Tensile elastic modulus (MPa) | | | |
|---|---|---|---|---|
| | Before immersion | | After 0.5 h of immersion | |
| | High tensile | Low tensile | High tensile | Low tensile |
| | elastic | elastic | elastic | elastic |
| | modulus | modulus | modulus | modulus |
| | direction | direction | direction | direction |
| | E_{MaxB} | E_{MinB} | E_{Max0.5} | E_{Min0.5} |
| Comparative | 698.62 | 682.61 | 635.97 | 523.87 |
| Example 1 | | | | |
| Comparative | 621.38 | 513.15 | 542.95 | 428.05 |
| Example 2 | | | | |
| Example 1 | 720.03 | 689.29 | 650.15 | 576.63 |
| Example 2 | 658.76 | 548.38 | 580.85 | 468.69 |
| Example 3 | 602.52 | 504.69 | 572.21 | 463.40 |

TABLE 2

| | Tensile elastic modulus (MPa) | |
|---|---|---|
| | After 24 h of immersion | |
| | High tensile | Low tensile |
| | elastic modulus direction | elastic modulus direction |
| | E_{Max24} | E_{Min24} |
| Comparative | 615.77 | 425.95 |
| Example 1 | | |
| Comparative | 488.64 | 311.07 |
| Example 2 | | |
| Example 1 | 611.59 | 471.51 |
| Example 2 | 476.24 | 376.44 |
| Example 3 | 551.57 | 438.84 |

TABLE 3

| | After 0.5 h of immersion | | | |
|---|---|---|---|---|
| | High tensile | Low tensile | | |
| | elastic modulus | elastic modulus | | |
| | direction | direction | | |
| | After immersion/ | After immersion/ | | Anisotropy of |
| | before immersion | before immersion | (E_{Min0.5}/E_{MinB})/ | elongation |
| | E_{Max0.5}/E_{MaxB} | E_{Min0.5}/E_{MinB} | (E_{Max0.5}/E_{MaxB}) | amount |
| Comparative | 0.91 | 0.77 | 0.85 | 8.6 |
| Example 1 | | | | |
| Comparative | 0.87 | 0.83 | 0.95 | 6.6 |
| Example 2 | | | | |
| Example 1 | 0.90 | 0.84 | 0.93 | 8.8 |
| Example 2 | 0.88 | 0.85 | 0.97 | 5.9 |
| Example 3 | 0.95 | 0.92 | 0.97 | 6.7 |

TABLE 4

| | After 24 h of immersion | | | |
|---|---|---|---|---|
| | High tensile | Low tensile | | |
| | elastic modulus | elastic modulus | | |
| | direction | direction | | |
| | After immersion/ | After immersion/ | | Anisotropy of |
| | before immersion | before immersion | (E_{Min24}/E_{MinB})/ | elongation |
| | E_{Max24}/E_{MaxB} | E_{Min24}/ E_{MinB} | (E_{Max24}/E_{MaxB}) | amount |
| Comparative | 0.88 | 0.62 | 0.70 | 13.0 |
| Example 1 | | | | |
| Comparative | 0.79 | 0.61 | 0.77 | 17.0 |
| Example 2 | | | | |
| Example 1 | 0.85 | 0.68 | 0.80 | 9.2 |
| Example 2 | 0.72 | 0.69 | 0.96 | 5.4 |
| Example 3 | 0.92 | 0.87 | 0.95 | 7.3 |

In Comparative Examples 1 and 2, the value of (E_{Min0.5}/E_{MinB})/(E_{Max0.5}/E_{MaxB}), as observed after 30 minutes of immersion in the electrolyte, was not less than 0.80. However, the value of (E_{Min24}/E_{MinB})/(E_{Max24}/E_{MaxB}), as observed after 24 hours of immersion in the electrolyte, was less than 0.80, and after 24 hours of immersion there was a large degree of anisotropy of the elongation amount.

In contrast, in Examples 1 and 2, the value of (E_{Min24}/E_{MinB})/(E_{Max24}/E_{MaxB}), as observed after 24 hours of immersion in the electrolyte, was not less than 0.80. Examples 1 and 2 each exhibited a lesser degree of anisotropy of elongation amount than Comparative Examples 1 and 2 (in which the value of (E_{Min24}/E_{MinB})/(E_{Max24}/E_{MaxB}) was less than 0.80). Note that, in Example 2 in particular, there was a large change in tensile elastic modulus as observed before and after immersion, but the anisotropy of elongation amount was reduced in comparison to the Comparative Examples. From this, it can be understood that rather than merely controlling the degree of softening after immersion, it is important to control the anisotropy of softening.

Example 3 assumes the case of a separator which has been removed from a nonaqueous electrolyte secondary battery that has been produced. Example 3 involved immersion, cleaning, drying, and a second immersion, but even in Example 3, it was confirmed that controlling the value of (E_{Min24}/E_{MinB})/(E_{Max24}/E_{MaxB}) so as to be not less than 0.80 made it possible to reduce the anisotropy of elongation amount.

### INDUSTRIAL APPLICABILITY

An aspect of the present invention can be used in producing a nonaqueous electrolyte secondary battery separator having reduced anisotropy of deformation which deformation occurs after immersion in an electrolyte.

### REFERENCE SIGNS LIST

10 Porous film
20 Porous layer

1. A nonaqueous electrolyte secondary battery separator comprising:
a polyolefin porous film,
the nonaqueous electrolyte secondary battery separator satisfying the following Expression 1:
(E_{Min24}/E_{MinB})/(E_{Max24}/E_{MaxB})≥0.80 (Expression 1)
where E_{MaxB}, E_{MinB}, E_{Max24}, and E_{Min24} are each a tensile elastic modulus of respective ones of test pieces obtained from the nonaqueous electrolyte secondary battery separator,
E_{MaxB} being a tensile elastic modulus as observed (i) before immersion in propylene carbonate and (ii) in a direction in which tensile elastic modulus is highest,
E_{MinB} being a tensile elastic modulus as observed (i) before immersion in propylene carbonate and (ii) in a direction in which tensile elastic modulus is lowest,
E_{Max24} being a tensile elastic modulus as observed (i) after 24 hours of immersion in propylene carbonate and (ii) in a direction in which tensile elastic modulus is highest,
E_{Min24} being a tensile elastic modulus as observed (i) after 24 hours of immersion in propylene carbonate and (ii) in a direction in which tensile elastic modulus is lowest.

2. A nonaqueous electrolyte secondary battery laminated separator comprising: the nonaqueous electrolyte secondary battery separator recited in claim 1; and a porous layer.

3. The nonaqueous electrolyte secondary battery laminated separator according to claim 2, wherein the porous layer contains at least one resin selected from the group consisting of a (meth)acrylate-based resin, a fluorine-containing resin, a polyamide-based resin, a polyimide-based resin, a polyester-based resin, and a water-soluble polymer.

4. The nonaqueous electrolyte secondary battery laminated separator according to claim 3, wherein the polyamide-based resin is an aramid resin.

5. A nonaqueous electrolyte secondary battery member comprising: a positive electrode; the nonaqueous electrolyte secondary battery separator recited in claim 1; and a negative electrode, the positive electrode, the nonaqueous electrolyte secondary battery separator, and the negative electrode being arranged in this order.

6. A nonaqueous electrolyte secondary battery comprising: the nonaqueous electrolyte secondary battery separator recited in claim 1.

7. A nonaqueous electrolyte secondary battery member comprising: a positive electrode; the nonaqueous electrolyte secondary battery laminated separator recited in claim 2; and a negative electrode, the positive electrode, the nonaqueous electrolyte secondary battery laminated separator, and the negative electrode being arranged in this order.

8. A nonaqueous electrolyte secondary battery comprising: the nonaqueous electrolyte secondary battery laminated separator recited in claim 2.
